(19) United States
(12) Patent Application Publication
(10) Pub. No.: US 2003/0115025 A1
(43) Pub. Date: Jun. 19, 2003

(54) Method and apparatus for wrapping existing procedure oriented program into component based system

(76) Inventors: Moon Soo Lee, Taejon (KR); Chul Hong Kim, Taejon (KR); Young Jong Yang, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/087,950

(22) Filed: Mar. 5, 2002

(30) Foreign Application Priority Data
Dec. 19, 2001 (KR) 2001-81106

(51) Int. Cl. G06F 17/50

(52) U.S. Cl. 703/1

(57) ABSTRACT

A method and apparatus for wrapping existing procedure oriented program into component based system are disclosed. In identification algorithm identifying a function capable of being reused in an existing system, user adjusts weighting value of basic constituent elements on the basis of only a general knowledge of a system such as use case without detailed knowledge about the system, so that a business logic is identified easily in top-down, and that a workflow of the system is identified in bottom-up to component wrap the identified business logic, thereby generating automatically the necessary constraint condition and the external interface.

### BACKGROUND OF THE INVENTION

1. Field of the Invention

The present invention relates to a method and apparatus for wrapping existing procedure oriented program into component based system, and in particular relates to a method and apparatus for wrapping existing procedure oriented program into component based system to identify the module based on workflow for the component wrapping and to produce reusable components using framework based wrapper.

2. Background of the Related Art

Legacy system is an important program for corporate strategy, and has been implemented with such procedural language as COBOL or FORTRAN for the latest several decades. However, due to the continuous amendments and additional functions its documentation has not been successfully accomplished and its maintenance costs continues to increase because of the deficiency of program man power.

In addition, the industry applicable software shall meet and actively be adapted to the market requirements though, the legacy system has become a serious obstacle in such a circumstance. There are categorized into some methods: Redevelopment, Transformation, and Wrapping, as a method which applies legacy system to new software schemes.

The Redevelopment method is developed by using new software schemes techniques different from the existing system, but has relatively problems such as time, cost and stability.

The Transformation method is a method which re-abstracts (restructures) the existing program with an object-oriented or component based software schemes, refreshes the system using the result information. Although the Transformation method can save time and cost because of using the information of the existing system compared to the Redevelopment method, the method still has a problem in respect of stability of the program.

Lastly, the Wrapping method has an advantage where it can easily reuse the new software architecture while continuously maintaining the existing system, different from above examples. However, such a wrapping method could be the cause that it will add to the complexity of the program even more as the software schemes develop.

Conventional wrapping technique has a fundamental problem in which the wrapping technique is focusing on the use of the present system only by modernizing the User Interface to New Interface.

Therefore, the wrapping results came to only add to the complexity of the program when they are to be reused. The best way to solve the problem is to differentiate the portions highly probable to be used in the future from the rest of the object to the wrapping, only user interface, and wrap the very portions only.

And the structure of wrapper shall also be developed in framework-based, so that the maintenance should be implemented easily.

Further, the wrapped resultants should be made as an independent component having a function. The reason is that the component containing an independent function has advantages not only of reuse and functional extension, but also being utilized easily in distributed environment such as web, since Component-Based Development (CBD) is able to include the legacy system in itself.

There is for example a software wrapping technique which is a field similar to techniques for modernization of the existing system as a method which apply legacy system to new software techniques. With regard to the software wrapping techniques, various methods have been proposed to perform object-wrapping of the data and the data structure of the existing system using object-oriented methodology (U.S. Pat. No. 6,305,007), to produce a wrapper having access to a CICS COBOL program which is operated in main program from different operating system environments using ECI (External Call Interface) API (U.S. Pat. No. 6,230,117), and to producing a wrapper for an application in its entirety because of having all meta information of the screens used in the existing application which includes a lot of business logic (U.S. Pat. No. 6,253,244).

Most of the conventional methods are focusing on a method for associating the existing program with a new system or program environment only, do not take account of the software evolution of the resultants.

Identifying procedure and clustering of the existing program to be a wrapping object need some handling such as experience or direct observation of user.

Therefore, the procedures of identifying the portions of highly probable to be reused and wrapping the identified module should be performed seamlessly in the case of transferring the existing system to a new program environment. Further more, there is needed framework-based wrapper of the architecture structure that has consistency in the wrapping results to facilitate maintenance and software evolution after this.

### SUMMARY OF THE INVENTION

Accordingly, the present invention has been proposed to solve the problem stated above. An object of the present invention is to provide a method and apparatus for wrapping existing procedure oriented program into component based system so as to automatize procedures which analyze a source code with handling by a developer, identify a reuse module using experience and direct observation, and wrap it, by means of tool support, and to provide even more systematic method.

Another object of the present invention is to provide a recording medium capable of being read by a computer, in which a program for performing a method for wrapping existing procedure oriented program into component-based system written.

To achieve the above objects, the present invention is characterized in identification algorithm identifying a function capable of being reused in an existing system, user adjusts some weights of the basic constituent elements on the basis of only a general knowledge of a system such as Use-case without any detailed knowledge about the system, so that a business logic is identified easily in top-down, and then a workflow of the system is identified component in bottom-up to wrap the identified business logic, thereby generating automatically the necessary constraint condition and the external interface. And the present invention is characterized to provide component-wrapping process to further facilitate maintenance and systematization using framework based intermediate framework.

According to one aspect of the present invention, an apparatus for wrapping existing procedure oriented program into component based system comprises: code analyzing portion extracts some information that is necessary for program analysis in source program or codes implemented by a procedural language; business logic identifying portion can find some component candidates that has very high probability of reuse using the information of the program analysis results extracted in the code analyzing portion; and component wrapper generating portion generates automatically the source codes for wrapping the existing program workflow which includes business logic identified in the business logic identifying portion.

The component wrapper generating portion comprises: component framework for reusing existing system as a component; legacy framework which is a framework of system to be associated with the component framework; and intermediate framework for linking the component framework with the legacy framework, and capturing screen information which is input/output to/from the legacy framework, thereby automatically communicating the information with each framework.

The intermediate framework comprises: program scheduler having navigation information and interaction relationship between each programs, and having schedule information about whether a plurality of screens are for input or output; meta-data repository storing meta-information for the screen of programs included in a pre-registered workflow; record handler for analyzing the command required by the component framework, obtaining the meta information of input/output data from the meta-data repository, thereby finding which are the screens entered from the present existing system and which are the input/output data corresponding to the screens, and for transferring the input/output data; and record adapter for receiving input screen from the legacy component, differentiating the data associated with the input/output from the information for displaying screen only, and providing it to the record handler.

According to another aspect of the present invention, a method for wrapping existing procedure oriented program into component based system comprises the steps of: extracting information for program analysis in source program or codes implemented with source procedural language; identifying a portion of very high probability of reuse using the information necessary for program analysis extracted in the code analyzing portion; and generating automatically the codes for wrapping program workflow which include business logic identified in the business logic identifying portion.

The step of identifying comprises the steps of: calculating the fitting index of user requirement using weight of the constituent elements configured by user depending on a scale of each modules in order to express business type to be identified; a) determining whether the calculated fitting index is the largest, if the fitting index is the largest, then searching the flows within program for executing module in the program including the module where the fitting index is the largest, b) searching input/output variables based on variables associated with screen decoration containing the direct relations with user; identifying automatically variables necessary for constraint condition and interface using input/output variables and flows (paths) within the identified program; and defining the variables to be constraint conditions and variables to be interface using the identified variables, to generate the code for the wrapping.

The calculation of the fitting index in the step of calculating the fitting index, lies in that it calculates fitness (fitting index) about the user requirement in Top-Down method which searches form large portion to small portion in scale. And the constraint condition consists of control variables necessary to obtain the flow for executing the module of the desired business logic, and wherein the interface consists of variables utilized in input/output portion of data.

In the process of searching the flows within the program and the input/output variables, the process comprises the following steps of: collecting the flow information between the paragraphs and the branch information to execute each paragraphs, searching call relations between the paragraphs using function call statement for connecting call relations between the modules; eliminating redundancy or recursive portions of the paragraph calls, if there are inclusive call relations, then reconstructing the paragraph call relations; identifying the flow of the program taking account of only unstructured statement; and generating call relation tree using the call relation information of the paragraph acquired as well as the program flow information of the unstructured sentence.

In the process of searching the flows within program and the input/output variables, the process comprises the steps of: analyzing the screen information of each variables and fields by analyzing the input/output variables which exist in the program containing business logic to be reused and the information about user interface or forms for expressing a screen; determining whether or not a field exists in the analyzed screen information; discriminating, if the field exists in the analyzed screen information, the field is a portion for input/output of actual data or only for decoration of screen; and a) registering, if the field is related with input/output (I/O) field, the field is registered as an input/output variable, b) un-registering, if the field is not for the portion for input/output, the field as meta data since the field is used as decoration of the screen.

The step of identifying automatically variables required for constraint condition and interface, comprises the following sub-steps of: selecting a unique path containing the workflow that user selected in the generated tree; checking whether there exist critical variable such as variables deciding the paragraph flow or input/output in the designated workflow; tracking, if there exists the critical variable, the list of variables affecting the critical variable using impact analysis, or tracking, if the variables are those transferred between programs, continuously the calling programs or the called programs and identifying the usage of variables; discriminating whether the identified variables are those of determining workflow path or those utilized as a constraint condition; and a) if the identified variables are used as a control variable, adding them to the list of the control variables, b) if the identified variables are used as a constraint condition, adding them to the list of the a constraint condition.

According to another aspect of the present invention, a recording medium capable of being read by a digital processing apparatus, in which programs capable of being executed by the digital processing apparatus are implemented by types so as to perform a method for wrapping existing procedure oriented program into component based system, wherein the method comprises the steps of: extracting information necessary for program analysis in source program or codes implemented with source procedural language; identifying a portion of very high probability of reuse using the information necessary for program analysis extracted in the code analyzing portion; and generating automatically the codes for wrapping program workflow including a desired business logic, and the step of identifying comprising the steps of: calculating the fitting index of user requirement using weight value of the constituent elements configured by user depending on a scale of each module in order to express business type to be identified; a) determining whether the calculated fitting index is the largest, if the fitting index is the largest, then searching the flows for executing the module in the program including the module where the fitting index is the largest, b) searching input/output variables based on variables associated with screen decoration containing the direct relations with user; identifying automatically variables necessary for constraint condition and interface using input/output variables and flows (path) within the searched program; and defining the variables to be constraint condition and variables to be interface using the identified variables, and then generate the code for the wrapping.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an apparatus for wrapping existing procedure oriented program into component based system in accordance with the present invention;

FIG. 2 is an operation flowchart of the identification algorithm which is performed in a business logic identifier depicted in FIG. 1;

FIG. 3a is a diagram illustrating structural elements for identifying the business logic of FIG. 2;

FIG. 3b is a diagram illustrating an exemplary picture configuration for setting constituent elements identifying the business logic depicted in FIG. 3a;

FIG. 4 is an operation flowchart of the detailed method searching the flow within the program depicted in FIG. 2;

FIG. 5a is a diagram illustrating an example of the source for the algorithm of FIG. 4;

FIG. 5b is a diagram illustrating an example of the picture configuration of Call Tree of FIG. 4 using the source of FIG. 5a;

FIG. 6 is an operation flowchart of the detailed searching method in the step of searching input/output variables depicted in FIG. 2;

FIG. 7 is a detailed operation flowchart of the step of identifying workflow of the business logic depicted in FIG. 2;

FIG. 8 is a detailed block diagram of the component wrapper generator of FIG. 1; and

FIG. 9 is a detailed block diagram of the intermediate framework of the component wrapper of FIG. 8.

### DETAILED DESCRIPTION OF THE PREFERRED EMBODIMENTS

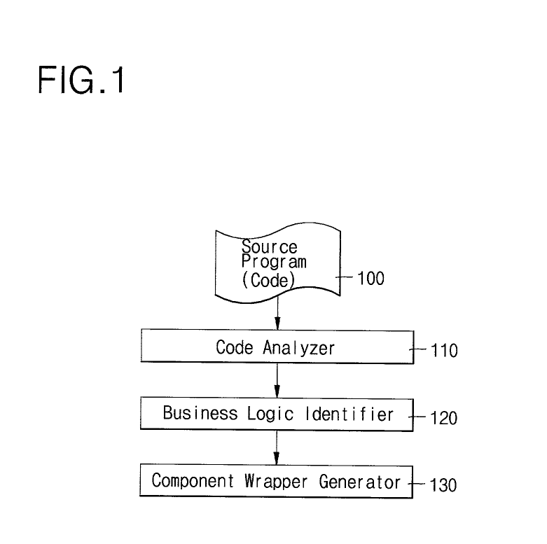

FIG. 1 is a block diagram of an apparatus for wrapping existing procedure oriented program into component-based system in accordance with the present invention. The apparatus may consist of a code analyzer 110, a business logic identifier 120 and a component wrapper generator 130.

The code analyzer 110 extracts information necessary for program analysis in the source programs or codes 100 which are implemented with a source procedural language, and provides it to the business logic identifier 120.

The business logic identifier 120 identifies a portion of very high probability of reuse using the information necessary for program analysis extracted in the code analyzer 110.

The component wrapper generator 130 generates automatically the codes for wrapping the workflow of the program, which includes the business logic identified in the business logic identifier 120.

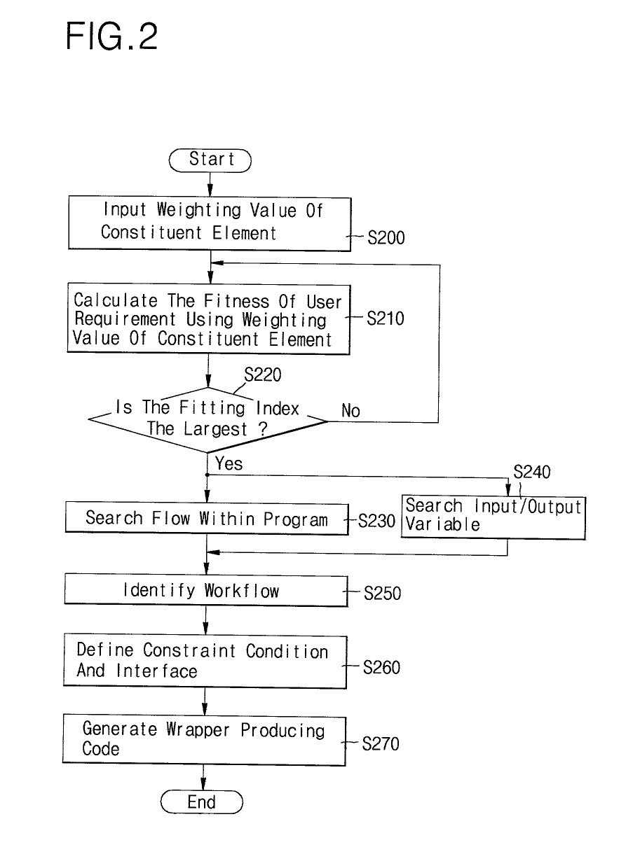

The concrete operation of the business logic identifier 120 will now be explained in detail with reference to FIG. 2. FIG. 2 is an operation flowchart of the identification algorithm which is performed in the business logic identifier showed in FIG. 1.

First, the weight values of the constituent elements are configured from user to express the type of the business logic to be identified (step S200).

The type of the business logic is identified using the weight values of the constituent elements configured by user depending on a scale of each module (step S200). That is, the scale of the module may be what is provided in each procedural language by the unit of program, paragraph or function, and capable of being physically divided independently or capable of being modularized to the minimum.

Fitness (fitting index) for the user requirement in Top-Down method which searches form large portion to small portion in scale, is calculated (step S210).

Determined is whether the calculated fitting index is the largest (step S220). If the fitting index is the largest, the flows for executing a module in the program including the module containing the largest fitting index, is searched, the flows of all the possible paths being found out (S230).

However, in the step S220, if the fitting index is not the largest, the user may select it directly.

Then, input/output variables are found out based on variables related to screen decoration containing direct input/output relations with user (step S240).

Subsequently, the flows within a program using input/output variables and paths within the selected program are identified, the variables related to the constraint condition and the interface necessary for it being found. The constraint condition consists of control variables necessary to obtain the flow for executing the module of the desired business logic, and the interface consists of variables utilized in input/output portion of data.

Therefore, also when workflow between the programs is identified in Bottom-Up, variables necessary for constraint condition and interface using variables related to screen input/output and variables that perform a program including business logic, are identified automatically (S250).

Then, the variables to be constraint condition and variables to be interface using the variables generated in workflow identification of the step S250 (step S260).

Accordingly, the component wrapper generator 130 shown in the FIG. 1 automatically generates the code for producing the framework-based wrapper using the workflow identified, ultimately (step S270).

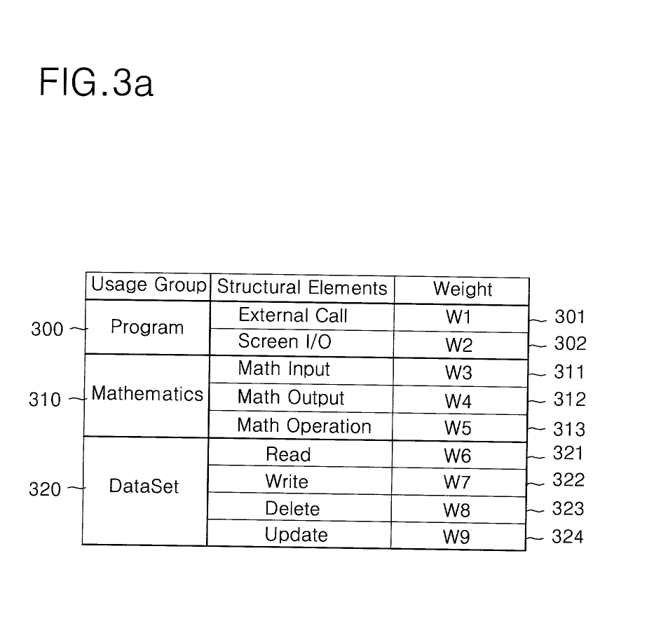

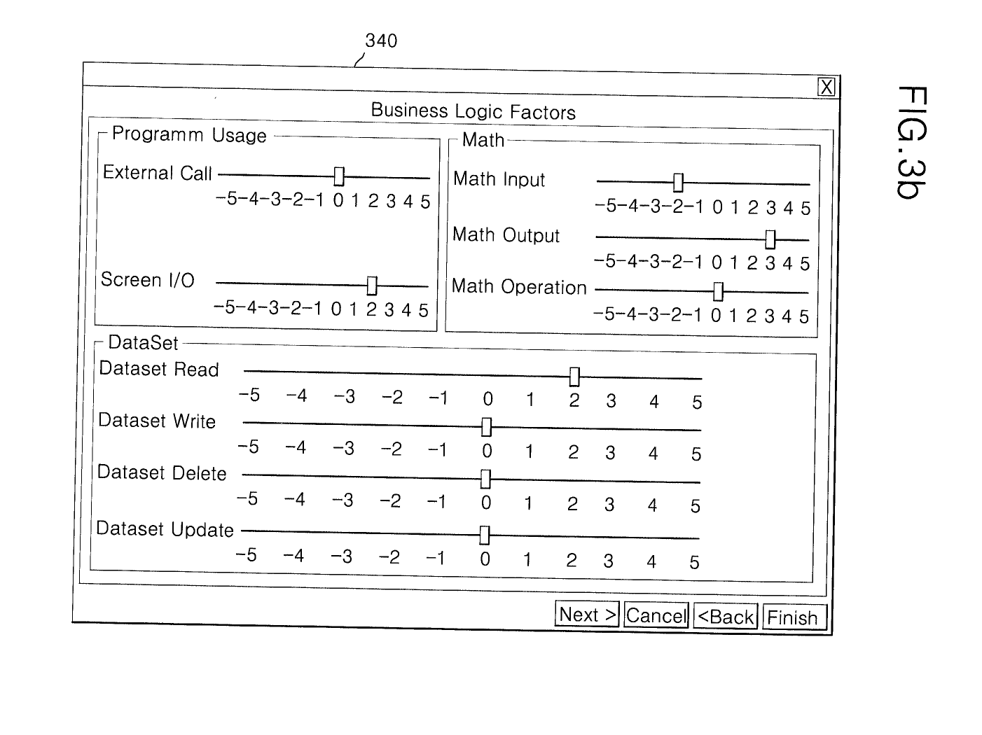

FIG. 3a is a diagram illustrating a list table of structural elements configured by user so as to express the type of the business logic to be identified.

In FIG. 3, usage of program (Program) 300 relates to that of program level, and consists of external program call (External Call) 301 and input/output of screen (Screen I/O) 302.

The usage of mathematics (Mathematics) 310 relates to an operation of input/output variables in a statement, that is, assignment or calculation of a value. The usage of mathematics 310 consists of Math Input 311 in which a variable related to input assign a value to another variable, Math output 312 which replaces the value with a variable related to output, and Math Operation 313 which calculates input/output variables.

The usage of DataSet 320 relates to data store in a file or different database. The usage of dataset 320 consists of Read 311, Write 322, Delete 323 and Update 324.

FIG. 3b is an exemplary picture configuration for setting constituent elements, and illustrates a setup picture for constituent elements of business logic.

User adjusts weight of desired constituent elements so that a business logic required by user is automatically identified. For example, if the user wants to find the business logic related to inquiry function, the user can find it by setting high the weight values of the screen input/output 302, the replacement 312 and the DataSet read 311.

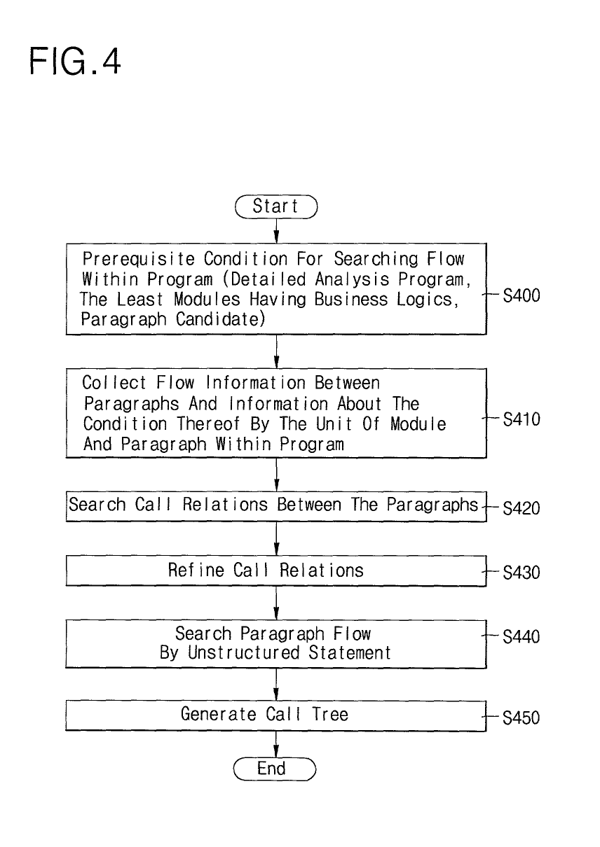

FIG. 4 is an operation flowchart of the detailed method searching the flow within the program depicted in FIG. 2.

In the step of performing the flow search within program of the step S250 showed in the FIG. 2, the program including business logic to be reused has been already known.

Therefore, we assume that a program for the detailed analysis, the least modules having business logics, and the paragraph candidates are known, as prerequisite condition for the flow search within program of the step S250 showed in the FIG. 2 (step S410).

In order to handle the detailed information of the program systematically, the flow information between paragraphs and the information about the condition thereof by the unit of modules and paragraphs are collected (step S410).

Then, call relations between the paragraphs using function call statement such as CALL sentence and PERFORM sentence in COBOL are searched for searching call relations between the modules (step S420).

In step S430, in order to refine the call relations, redundancy or recursive portions of the paragraph calls is eliminated. If there are inclusive call relations, then the inclusive call relations are reconstructed (step S430).

Subsequently, in order to search the paragraph flow by the unstructured statement, the flow of the program is identified taking account of only unstructured statement sentence, for example GO TO sentence, CONTINUE sentence and BREAK sentence, of the flow information between the paragraphs (step S440).

Then, the call tree expressing the produced call relations of paragraphs is generated (step S450). That is, call relation tree is generated using the call relation information of the paragraph acquired in the step S430 and the program flow information of the unstructured sentence in the step S440.

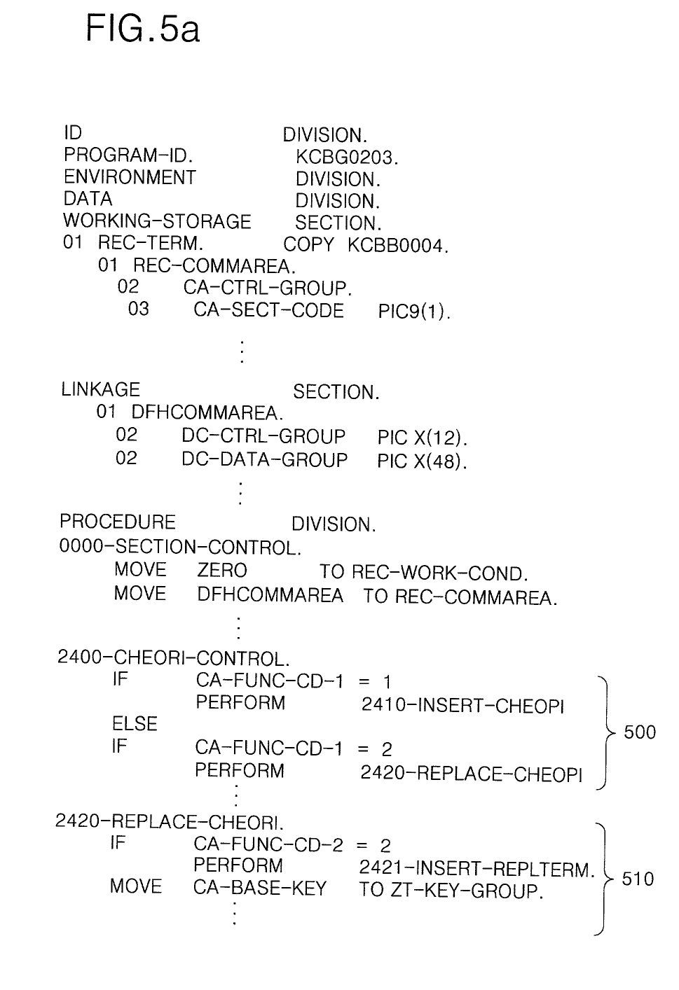

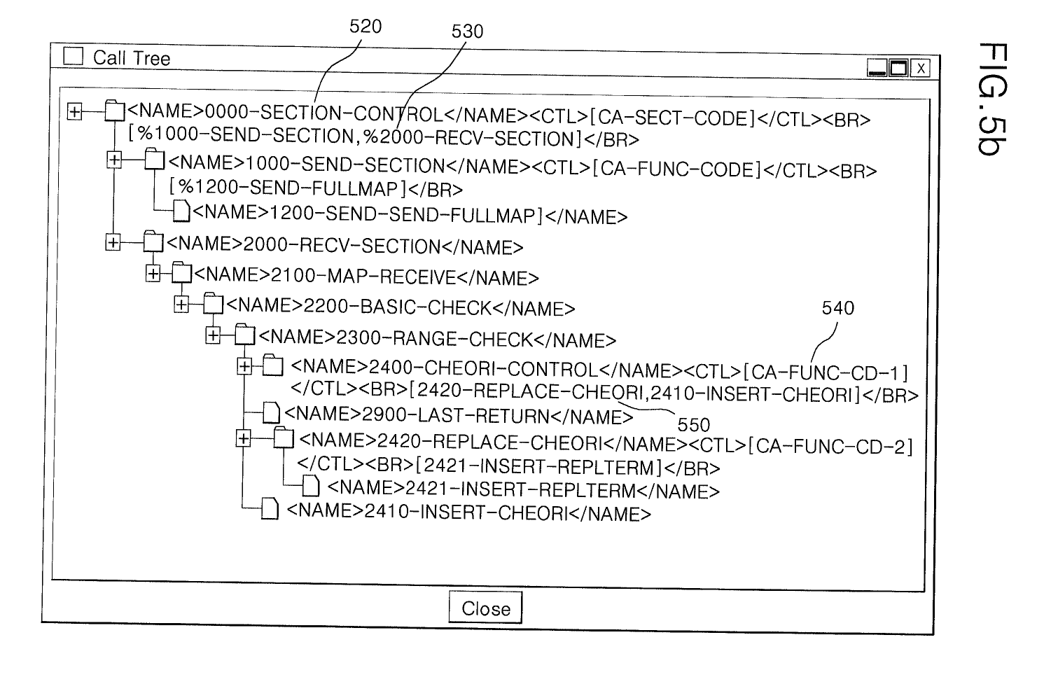

FIG. 5a is a diagram illustrating an example of the source for the algorithm of FIG. 4. FIG. 5b is a diagram illustrating an example of the picture configuration of Call Tree of FIG. 4 using the source of FIG. 5a.

FIG. 5b is a diagram displaying the call relation tree in picture by using algorithm in FIG. 4, and analyzing program source showed in FIG. 5a.

Meta-data for the call relation tree is expressed as XML format. <NAME> tag expresses paragraph name 520. <CTL> tag expresses a control condition list 540 for call or navigation to different paragraphs. Also, <BR> tag expresses paragraph list 550 to be called or navigated next.

The paragraph list 550 to be called or navigated next express the unstructured sentence such as GOTO sentence of paragraph name 530 of which first character of the name begin at “%”.

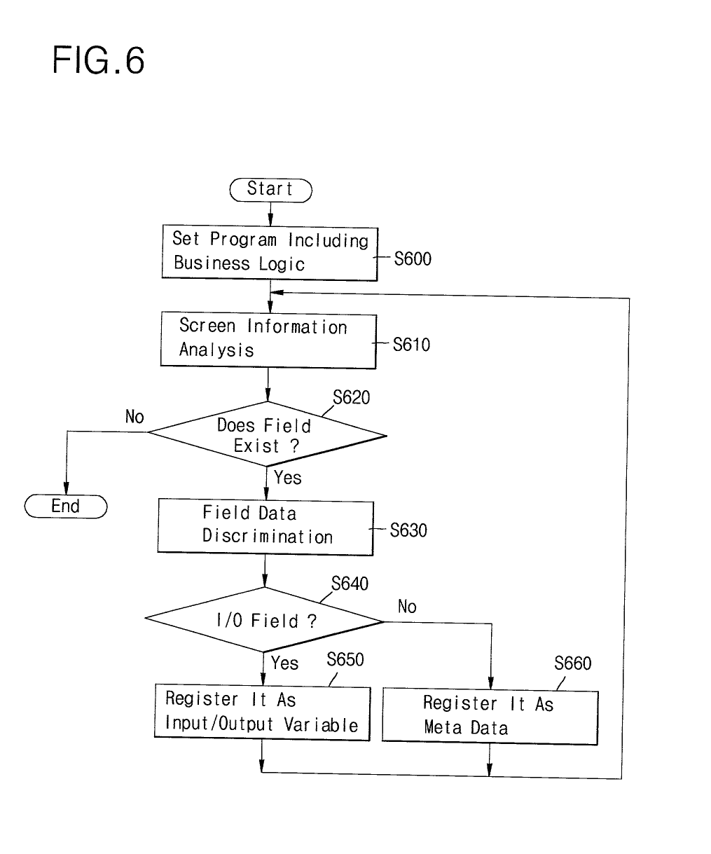

FIG. 6 is an operation flowchart of the detailed searching method in the step of searching input/output variables illustrated in FIG. 2. That is, FIG. 6 is a flowchart of method for searching the input/output variables of the outside of program illustrated in FIG. 2.

As illustrated in FIG. 6, since a program having business logic to be reused is known, the screen information or file related the program can be known (step S600).

The screen information of each variable and field is analyzed by analyzing the input/output variables which exist in the program, the information about user interface or forms for expressing a screen (step S610).

Then, it is determined whether or not a field exists in the analyzed screen information (step S620). If the field exists in the analyzed screen information, it is discriminated whether the field is a portion for input/output of actual data or only for decoration of screen (step S630). And, it is determined whether the field is corresponding to the input/output (I/O) field (step S640).

If the field is for input/output field, the field is registered as an input/output variable since the field is used as input/output variable (step S650). But, if the field is not for the portion for input/output, the field is registered as meta data since the field is used as decoration of the screen (step S660).

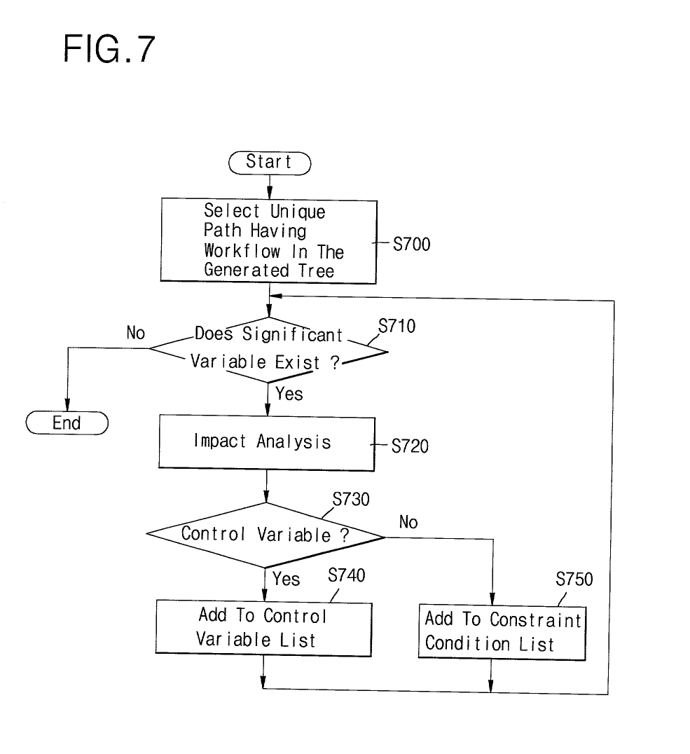

FIG. 7 is a detailed operation flowchart of the step of identifying workflow of the business logic depicted in FIG. 2.

First, the unique path having the workflow that user wants in the generated tree produced in the step S450 of FIG. 4 is selected (step S700).

Then, it is checked whether there exist critical variable such as variables deciding the paragraph flow or input/output in the designated workflow (step S710).

If there exists the critical variable, the list of variables affecting the critical variable using impact analysis is tracked. Or if the variables are those transferred between programs, the calling programs or the called programs is continuously tracked whereby the usage of variables is identified (step S720).

Subsequently, it is discriminated whether the identified variables are those of determining workflow path or those utilized as a constraint condition (step S730).

If the identified variables are used as a control variable, they are added to the list of the control variables (step S740). But, if the identified variables are used as a constraint condition, they are added to the list of the constraint condition, this list becomes a interface candidate of component produced later (step S750).

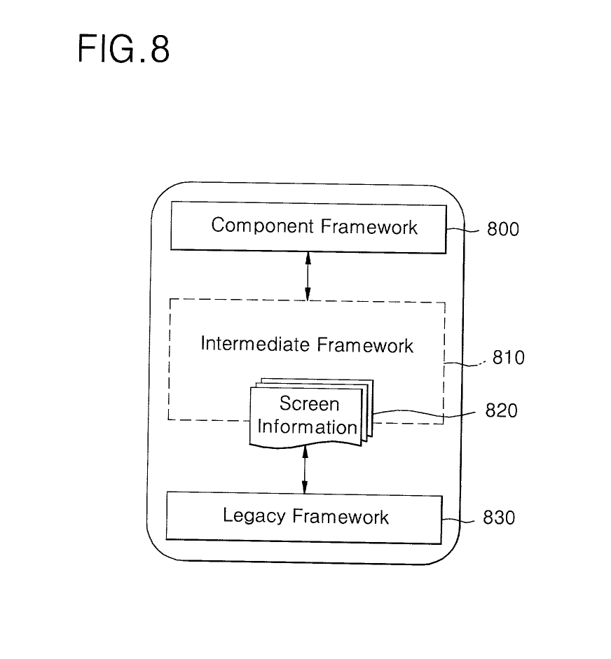

FIG. 8 is a detailed block diagram of the component wrapper generator of FIG. 1.

Component wrapper serves to wrap the workflow to be reused in existing system into component. The whole constitution of component system including a component wrapper is divided generally into a component framework 800, an intermediate framework 810 and a legacy framework 830.

The component framework 800 serves to reuse existing system as a component. The legacy framework 830 is a system framework associated with the component framework 800.

The intermediate framework 810 serves to link the component framework 800 with the legacy framework 830, and capture screen information which is input/output to/from the legacy framework, thereby automatically inserting or extracting the information.

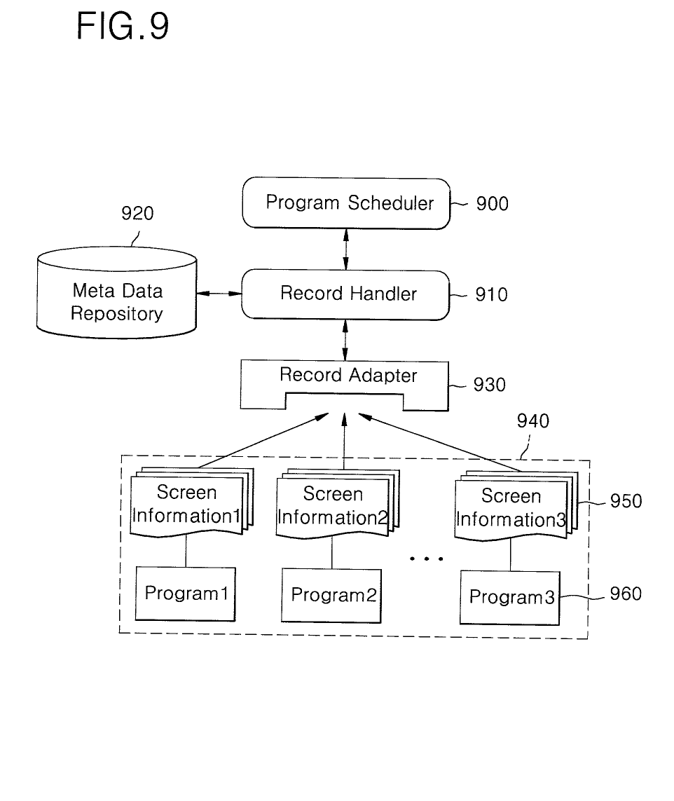

FIG. 9 is a detailed block diagram of the intermediate framework of the component wrapper of FIG. 8.

As illustrated in FIG. 9, intermediate framework 810 consists of a program scheduler 900, a record handler 910, a meta data pool 920 and a record adapter 930.

The program scheduler 900 has navigation information and interaction relationship between programs. Program interaction relationship has the information about how the program is used for any use of input, output or input/output uses. For example, if the screen configuration of existing system comprises menu display firstly, an inquiry menu is selected by user, and the inquiry contents are showed in the next screen, the program scheduler 900 does not only have both of two screens flow information, but also has the information about whether each screen is for input or for output. That is, the menu screen is to be used as input usage, while the inquiry result screen is to be used as output usage.

The meta-data pool 920 has meta-information for the screens of programs included in a workflow registered in the step S660 of FIG. 6.

The record handler 910 analyzes the command required by the component framework 800 showed in FIG. 8, obtains the meta information of input/output data from the meta-data pool, and finds which are the screens entered from the present existing system and which are the input/output data corresponding to the screens, thereby transferring the input/output data.

The record adapter 930 receives input screen from the legacy component, differentiates the data associated with the input/output from the information for display of screen only, and provides it to the record handler 910.

The record handler 910 does not only stores temporarily the information of legacy component, but also transforms different characters of ASCII, EBCDIC, etc.

As described above, a method and apparatus for wrapping existing procedure oriented program into component based system according to the present invention, saves cost and time required to understand the existing system by identifying automatically a significant business logic of system using only a information of general program configuration without detailed knowledge for implementing the existing system.

Also, the present invention maintains stability which is the advantage of the existing system by using software wrapping schemes, and reuses the existing system associated with system of new circumstance such as web, and also easily adds new functions, if necessary, by identifying portions capable of being reused and wrapping it into component.

Further, the present invention provides expandability in software evolution in the future and maintenance since the proposed software wrapping scheme has framework based wrapper structure, rather than screen scraping for wrapping only portions of screen.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for wrapping existing procedure oriented program into component based system, comprising:
a code analyzing portion for extracting information necessary for program analysis in source program or codes implemented with source procedural language;
a business logic identifying portion for identifying a portion of very high probability of reuse using the information necessary for program analysis extracted in the code analyzing portion; and
a component wrapper generating portion for automatically generating the codes for wrapping the program workflow which includes business logic identified in the business logic identifying portion.

2. The apparatus as claimed in claim 1, wherein the component wrapper generating portion comprises:
a component framework for reusing existing system as a component;
a legacy frame work which is a framework of system to be associated with the component framework; and
an intermediate framework for linking the component framework with the legacy frame work, and capturing screen information which is input/output to/from the legacy framework, thereby automatically inserting or extracting information.

3. The apparatus as claimed in claim 2, wherein the intermediate framework comprises:
a program scheduler having voyage information and interaction relationship between programs, and having schedule information about whether a plurality of screens are for input or for output;
a meta-data pool for storing meta-information for the screens of programs included in a pre-registered workflow;
a record handler for analyzing the commend required by the component framework, obtaining the meta information of input/output data from the meta-data pool, thereby finding which are the screens entered from the present existing system and which are the input/output data corresponding to the screens, and for transferring the input/output data; and
a record adapter for receiving input screen from the legacy component, differentiating the data associated with the input/output from the information for display of screen only, and providing it to the record handler.

4. The apparatus as claimed in claim 3, wherein the record adapter stores temporarily the information of legacy component, and transforms different characters of ASCII, EBCDIC, etc.

5. The apparatus as claimed in claim 3, wherein the program scheduler stores the information about how the program is used for any usage of input, output or input/output usage.

6. A method for wrapping existing procedure oriented program into component based system, comprising the steps of:
extracting information necessary for program analysis in source program or codes implemented with source procedural language;
identifying a portion of very high probability of reuse using the information necessary for program analysis extracted in the code analyzing portion; and
generating automatically the codes for wrapping program workflow which include business logic identified in the business logic identifying portion.

7. The method as claimed in claim 6, wherein the step of identifying comprises the steps of:
calculating the fitting index of user requirement using weighting value of the constituent elements inputted by user depending on a scale of each module in order to express business type to be identified;
a) determining whether the calculated fitting index is the largest, if the fitting index is the largest, then searching the flows within program for executing module in the program including the module where the fitting index is the largest,
b) searching input/output variables based on variables associated with screen decoration having the direct relations with user;
identifying automatically variables necessary for constraint condition and interface using input/output variables and flows (path) within the searched program; and
defining the variables to be constraint condition and variables to be interface using the identified variables, to generate the code for the wrapping.

8. The method as claimed in claim 6, wherein the calculation of the fitting index in the step of calculating the fitting index, lies in that it calculates fitness (fitting index) about the user requirement in Top-Down method which searches form large portion to small portion in scale.

9. The method as claimed in claim 7, wherein the constraint condition consists of control variables necessary to obtain the flow for executing the module of the desired business logic, and wherein the interface consists of variables utilized in input/output portion of data.

10. The method as claimed in claim 7, wherein in the step of searching the flows within the program and the input/output variables, the step of searching the flows within the program comprises the steps of:
collecting the flow information between paragraphs and the information about the condition thereof by the unit of modules and paragraphs in order to adjust the inferior information of the program systematically when the programs for the detailed analysis of program, the least modules having business logics, and the paragraph candidates are known, searching call relations between the paragraphs using function call statement for searching call relations between the modules;
eliminating redundancy or recursive portions of the paragraph calls, if there are inclusive call relations, then reconstructing the paragraph call relations; identifying the flow of the program taking account of only unstructured statement sentence of the flow information between the paragraphs for searching the paragraph flow by the unstructured statement; and
generating call relation tree using the call relation information of the paragraph acquired and the program flow information of the unstructured sentence.

11. The method as claimed in claim 7, wherein in the step of searching call relations between the paragraphs, the function call statement utilizes CALL sentence and PERFORM sentence in COBOL.

12. The method as claimed in claim 10, wherein in the step of identifying the flow of the program, the unstructured statement utilizes at least one of GO TO sentence, CONTINUE sentence and BREAK sentence in COBOL.

13. The method as claimed in claim 7, wherein in the step of searching the flows within program and the input/output variables, the step of searching the input/output variables comprises the steps of:
analyzing the screen information of each variable and field, by analyzing the input/output variables which exist in the program having business logic to be reused, the information about user interface or forms for expressing a screen;
determining whether or not a field exists in the analyzed screen information;
discriminating, if the field exists in the analyzed screen information, whether the field is a portion for input/output of actual data or only for decoration of screen; and
a) registering, if the field is for input/output (I/O) field, the field as an input/output variable since the field is used as input/output variable,
b) registering, if the field is not for the portion for input/output, the field as meta data since the field is used as decoration of the screen.

14. The method as claimed in claim 7, wherein the step of identifying automatically variables necessary for constraint condition and interface, comprises the steps of:
selecting Unique Path having the workflow that user wants in the generated tree;
checking whether there exist Critical variable such as variables deciding the paragraph flow or input/output in the designated workflow;
tracking, if there exists the critical variable, the list of variables affecting the critical variable using impact analysis, or tracking, if the variables are those transferred between programs, continuously the calling programs or the called programs and identifying the usage of variables;
discriminating whether the identified variables are those of determining workflow path or those utilized as a constraint condition; and
a) if the identified variables are used as a control variable, adding them to the list of the control variables,
b) if the identified variables are used as a constraint condition, adding them to the list of the a constraint condition.

15. A recording medium capable of being read by a digital processing apparatus, in which programs capable of being executed by the digital processing apparatus are implemented by types so as to perform a method for wrapping existing procedure oriented program into component based system, wherein the method comprises the steps of:
extracting information necessary for program analysis in source program or codes implemented with source procedural language;
identifying a portion of very high probability of reuse using the information necessary for program analysis extracted in the code analyzing portion; and
generating automatically the codes for wrapping program workflow which includes business logic identified in the business logic identifying portion,
the step of identifying comprising the steps of:
calculating the fitting index of user requirement using weighting value of the constituent elements inputted by user depending on a scale of each module in order to express business type to be identified;
a) determining whether the calculated fitting index is the largest, if the fitting index is the largest, then searching the flows within program for executing module in the program including the module where the fitting index is the largest,
b) searching input/output variables based on variables associated with screen decoration having the direct relations with user;
identifying automatically variables necessary for constraint condition and interface using input/output variables and flows (path) within the searched program; and
defining the variables to be constraint condition and variables to be interface using the identified variables, to generate the code for the wrapping.
